(19) United States
(12) Patent Application Publication
(10) Pub. No.: US 2013/0037127 A1
(43) Pub. Date: Feb. 14, 2013

(54) Pneumatic Tire Valve Snap Fastener Cap and Method of Using Same

(71) Applicant: Ron Allen, Lakewood, CA (US)

(72) Inventor: Ron Allen, Lakewood, CA (US)

(21) Appl. No.: 13/572,291

(22) Filed: Aug. 10, 2012

Related U.S. Application Data
(60) Provisional application No. 61/523,128, filed on Aug. 12, 2011.

(51) Int. Cl. F16L 55/115; B23P 6/00

(52) U.S. Cl. 137/232; 29/890.121

(57) ABSTRACT

A universal valve cap for pneumatic tire valve stems allows for quick and easy access to replenish air in tires. The bottom portion of the cap has an inner thread design, engagable with the threaded valve stem, and the top or crown part of the cap has a snap fastener fitting, allowing for inflation of the tire. The upper portion of the cap has a compression spring or memory plastic that offers resistance to a compressive force that will enable the upper section of the cap to be pressed down over the stationary bottom half of the cap when pressure is applied. The bottom portion of the cap can be pushed down and locked into an open position when inserting air or checking tire pressure. A twist of the cap releases the upper portion to its original position, allowing the top of the cap to be snapped closed.

### CROSS-REFERENCE TO RELATED APPLICATIONS

This is a Non-Provisional Application claiming the benefit of co-pending Provisional Application No. 61/523,128 filed Aug. 12, 2011.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

All pneumatic tire valve stems, whether for automobiles, bicycles, or any other vehicle utilizing pneumatic tires, are utilized whenever tires are replaced or for maintaining proper tire inflation pressure. Currently, a fairly generic cap, having, screw threads for engaging complementary threads on the tip of the valve stem, is used to cover and protect the stem portion of the valve. While this approach has been the standard for decades, there are problems that present themselves with these standard caps. One such problem is the inconvenience of having to remove all of the valve caps on tires before checking pressure and/or inflating the tires. This step can lead to the loss of individual valve stem caps, and having to either replace them or leave the valve stems exposed to all of the elements of the weather, such as water, mud, dirt, and any related problems associated with roadway surfaces.

Also, in the present world of self-service fueling stations, where coin-operated air pumps are the norm, speed is of the essence, meaning that having to unscrew four valve stem caps and avoid losing them is one more frustration to deal with. Given the importance of fuel economy and our environment, to keep our tires properly inflated, there is a need to do everything reasonable to make the checking and inflating process as painless as possible.

Accordingly, there is presently a need for a valve stem cap that will provide a fast and convenient way to address the above-noted problems.

### BRIEF SUMMARY OF THE INVENTION

By way of brief summary, one form of the tire valve cap system of the present invention comprises a lower member having threads for engaging complementary threads on a tire valve stem and an upper member movable over the lower member between an upward orientation and a downward orientation relative to the lower member. In an alternate form of the invention, a tire valve system further comprises a biasing member for biasing the lower member toward its upward orientation.

With the foregoing in mind, it is an object of the invention to provide a novel tire valve system that will permit the user to efficiently check tire pressure and appropriately inflate the tires on the vehicle without having to remove all of the valve caps on the tires.

Another object of the invention is to provide a novel tire valve system that permits the user to check tire pressure and appropriately inflate the tires on the vehicle in a convenient manner that prevents the loss of individual valve stem caps and prevents having to either replace the valve stem caps or leave the valve stems exposed to the adverse elements of the weather.

Another object of the invention is to provide a novel tire valve system of the aforementioned character that permits the user to check tire pressure and appropriately inflate the tires on the vehicle in a rapid and efficient manner.

Another object of the invention is to provide a novel tire valve system of the character described in the preceding paragraphs that is easy to use, inexpensive to manufacture, and one that enables the user to keep the vehicle tires properly inflated to thereby achieve maximum fuel economy.

### BRIEF DESCRIPTION OF SEVERAL VIEWS OF THE DRAWINGS

FIG. 1 is a generally perspective view of one embodiment of a tire valve stem cap constructed in accordance with the principles of the present invention wherein the cap is in a closed configuration and wherein the device is in position over a tire valve stem.

FIG. 2 is a view similar to FIG. 1, showing the cap in an open configuration and showing the sleeve of the device in a downward position.

FIG. 3 is a cross-sectional view of the device as depicted in FIG. 2.

FIG. 4 is a generally perspective, exploded view of the embodiment shown in FIG. 1.

FIG. 5 is a generally perspective view of an alternate embodiment of a tire valve stem cap of the invention showing the cap in a closed configuration.

FIG. 6 is a generally perspective view similar to FIG. 5, showing the cap in an open configuration.

FIG. 7 is a generally perspective, exploded view of the alternate embodiment shown in FIG. 5.

FIG. 8 is a generally perspective view of another embodiment of a tire valve stem cap of the invention showing the cap in an open configuration.

FIG. 9 is a side elevational view of the embodiment shown in FIG. 8.

FIG. 10 is a view taken along lines 10-10 of FIG. 9.

FIG. 11 is a greatly enlarged cross-sectional view of the area designated in FIG. 10 has 11-11.

FIG. 11A is a fragmentary, generally perspective view partly broken away to show internal construction of the embodiment of the invention shown in FIG. 8.

FIG. 11B is a fragmentary, generally perspective view similar to FIG. 11A showing the outer sleeve of the device in a downward configuration and rotated into a locking position.

### DETAILED DESCRIPTION OF THE INVENTION

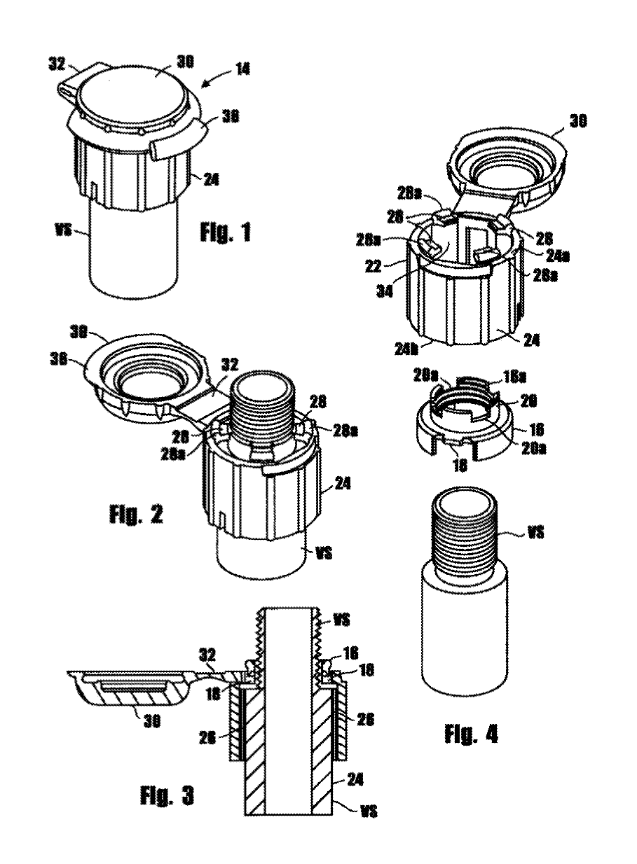

Referring now to the drawings and particularly FIGS. 1-4, one form of the tire valve stem cap assembly of the invention is there shown and generally designated by the numeral 14. Cap assembly 14 here comprises a lower metal member 16 that is provided with threads 16a to facilitate attachment to the upper threaded portion of a tire valve stem “VS” of the character well known in the art. Lower member 16 includes a pair of diametrically opposed, radially outwardly extending guide tabs 18 and an upstanding, reduced diameter portion 20 that is provided with a plurality of circumferentially spaced slots 20a. Cap assembly 14 further comprises an upper member 22 that includes a skirt 24 having an upper portion 24a and a lower portion 24b. Skirt 24 has a pair of diametrically opposed, internal guide grooves 26 that each receive one of the pair of radially outwardly extending guide tabs 18 so as to guide the downward travel of the upper member 22 over the lower member 16 into the position shown in FIGS. 2 and 3 of the drawings, wherein the tire valve stem is exposed. For a purpose presently to be described, the upper portion 24a of skirt 24 is provided with a plurality of circumferentially spaced, radially inwardly extending fingers 28, each having a rounded projection 28a.

A snap-latch fastener cover 30 is hingedly connected to the upper portion 24a of skirt 24 by a living hinge 32. In its closed position, cover 30 covers opening 34 (see FIG. 4) provided in the top portion of skirt 24 and can be pivoted about the hinge 32 between a closed orientation wherein the opening is covered, (see FIG. 1) and an open orientation wherein the opening 34 is uncovered (see FIG. 2). A flange or other suitable catch mechanism 36 is employed to removably engage the top portion of skirt 24 to latch the cover 30 in its closed orientation as shown in FIG. 1 of the drawings.

In normal operation, the tire valve stem cap 14 of the present invention is disposed as shown in FIG. 1 with the snap latch fastener cover 30 in a closed orientation and the upper member 24 in its natural upper orientation, covering the top of the valve stem “VS”. When it is desired to service the tire by checking the inflation pressure or adding air in accordance with one form of the method of the invention, the snap latch fastener cover 30 is pivoted about hinge 32, to its open orientation as shown in FIG. 2. When cover 30 is pivoted to its open orientation, the sleeve 22 falls by force of gravity to the position shown in FIGS. 2 and 3 so that the tire valve stem is accessible. Then, the tire gauge or air insertion device is placed over the tire valve stem in the usual fashion to fill the tire. Thus, what is provided is a simple and convenient method and apparatus for maintaining proper inflation pressure in tires, using a cap that does not need to be removed from the valve stem. This inventive system is designed to help the general public maintain the proper inflation pressure needed for safety and tire longevity by providing a quick and easy way of inserting and replenishing air for pneumatic tires of all designs and for all vehicular purposes.

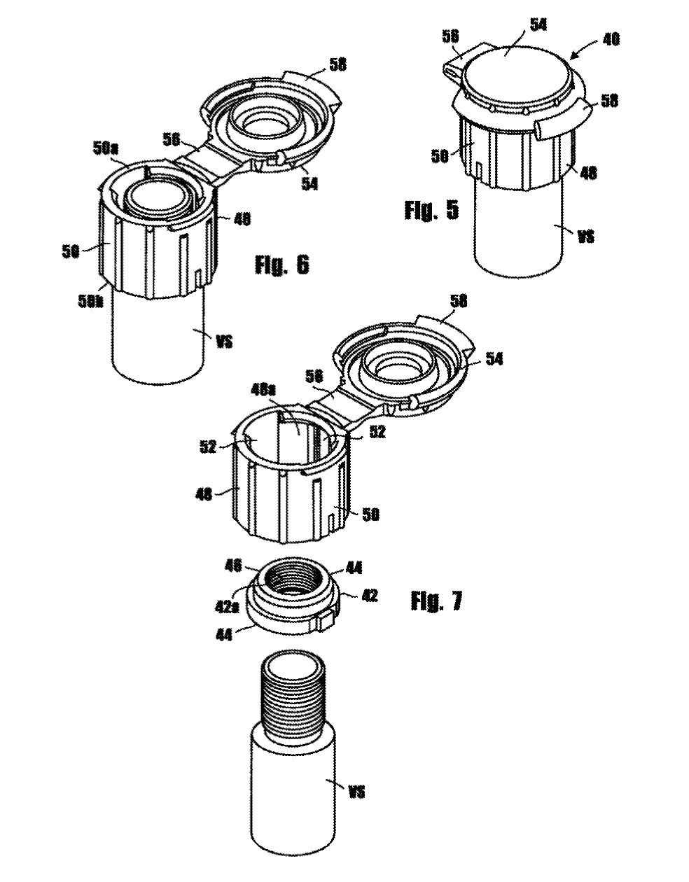

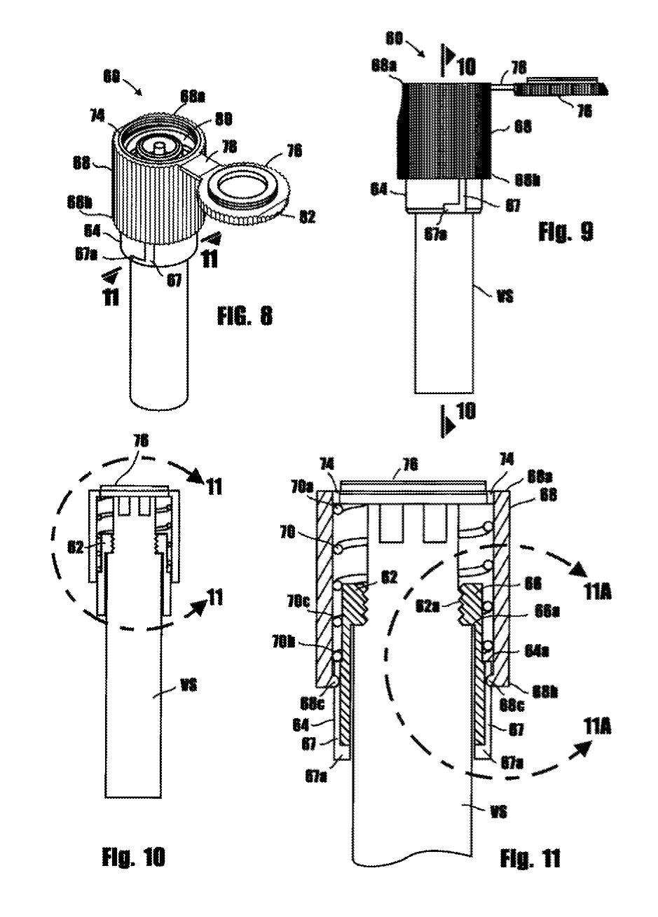

The modified embodiment of the invention shown in FIGS. 5-7, which is designated by the numeral 40, is similar in many respects to the embodiment of FIGS. 1-4 and operates in substantially the same manner. However, in this latest embodiment, the lower member 42 is constructed from a moldable plastic and is provided with threads 42a to facilitate attachment to the upper threaded portion of a tire valve stem “VS” (see FIG. 7). Lower member 42 includes a pair of radially, outwardly extending guide tabs 44 and an upstanding, reduced diameter portion 46. Cap assembly 40 further comprises an upper member 48 that includes a skirt 50 having an upper portion 50a and a lower portion 50b. Skirt 50 has a pair of guide grooves 52 that each receive one of the pair of radially, outwardly extending guide tabs 44, so as to guide the downward travel by force of gravity of the upper member 48 over the lower member 42 in the same manner as was described in connection with the first embodiment of the invention.

A snap-latch fastener cover 54 is hingedly connected to the upper portion of skirt 50 by a living hinge 56. In its closed position, cover 54 covers opening 48a provided in the top portion of skirt 48 and can be pivoted about the hinge 56 between a closed orientation (see FIG. 5), wherein the opening is covered, and an open orientation (see FIG. 6), wherein the opening 48a is uncovered. As before, a flange or other suitable catch mechanism 58 is employed to latch the cover 54 in its closed orientation.

In normal operation, the tire valve stem cap of the present invention is disposed as shown in FIG. 5, with the snap latch fastener cover 54 in a closed orientation and the upper member in its natural upper orientation, covering the top of the valve stem “VS”. When it is desired to service the tire, by checking the inflation pressure or adding air in accordance with one form of the method of the invention, the snap latch fastener cover 54 is pivoted about hinge 56 to its open orientation. When the cover 54 is pivoted to its open orientation, the skirt 48 falls by force of gravity to the downward position so that the tire valve stem is accessible. Then, the tire gauge or air insertion device is placed over the tire valve stem in the usual fashion to fill the tire.

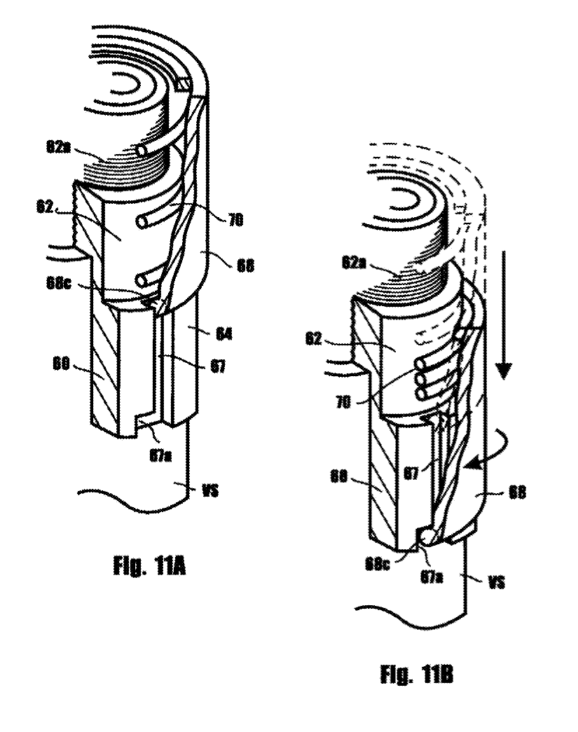

Turning next to FIGS. 8- 11, 11A, and 11B, still another form of the cap assembly of the invention is there shown and generally designated by the numeral 60. This embodiment is also similar in some respects to the embodiment of FIGS. 1-4, and as will presently be described, operates in a somewhat different manner. Cap assembly 60 here comprises an inner member 62 that is provided with threads 62a to facilitate attachment to the upper threaded portion of a tire valve stem “VS” (FIG. 10). Inner member 62 here includes a skirt portion 64 having a shoulder 64a and a had portion 66 having a shoulder 66a (FIG. 11). For a purpose presently to be described, skirt portion 64 also has three circumferentially spaced locking grooves 67, each having an outwardly extending foot 67a.

Cap assembly 60 further comprises an outer member 68 that includes an upper portion 68a, a lower portion 68b, and three circumferentially spaced, inwardly extending locking protuberances 68c that ride within locking grooves 67 (see FIG. 11). An important feature of this latest form of the invention is a coil spring 70 which is located within outer member 68. Coil spring 70 has an upper extremity 70a, a lower extremity 70b, and a lower portion 70c that partially circumscribes member 60. To appropriately locate the spring, the lower extremity of the spring is disposed in engagement with shoulder 64a of skid portion 64. A conventional snap ring 74 positioned within the upper portion 68a of member 68 (FIGS. 8 & 11) functions to retain spring 70 in position within the outer member.

A snap-latch fastener cover 76 is hingedly connected to the upper portion 68a of outer member 68 by a living hinge 78. In its closed position, cover 76 covers opening 80 (see FIG. 11), provided in the top portion of outer member 68, and can be pivoted about the hinge 78 between a closed orientation, wherein the opening is covered, and an open orientation, wherein the opening is uncovered. A flange or other suitable catch mechanism 82 (see FIG. 8) is employed to latch the cover in its closed orientation.

In normal operation, the tire valve stem cap 60 of the present invention, is disposed as shown in FIGS. 10 and 11 with the snap latch fastener cover 76 in a closed orientation and the outer member 68 in its natural upper orientation, covering the top of the valve stem “VS”.

When it is desired to service the tire in order to check the tire inflation pressure or to appropriately add air to the tire in accordance with an alternate form of the method of the invention, the snap latch fastener cover 76 is pivoted about hinge 78 to its open orientation as shown in FIGS. 8 and 9, so that the opening 80 is accessible. Then, the tire gauge or air insertion device (not shown) is placed over the tire valve stem in the usual fashion. The downward pressing of the tire gauge/air insertion device will act to push the upper member 68 to its downward orientation as shown in FIG. 11B, so that the tire valve stem is exposed and fully accessible to the tire gauge or compressor air valve. Alternatively, the user can manually push the upper member 68 to its downward orientation and rotate it relative to the inner member 62 in the manner shown in FIG. 11B so that the inwardly extending locking protuberances 68c will enter the foot portions 67a of the grooves, thereby locking the upper member 68 in its downward orientation during the entire servicing process. When the tire has been serviced, the upper member 68 is rotated relative to the inner member 62 to its starting position so that the inwardly extending locking protuberances 68c will exit the foot portions 67a of the grooves. This will release the upper member 68 from its downward orientation, thus permitting the biasing member 70 to return the outer member 68 to the upward orientation shown in FIG. 11A. The snap latch fastener cover 76 is then closed, thus returning the tire valve stem to its encapsulated condition.

Accordingly, although an exemplary embodiment of the invention has been shown and described, it is to be understood that all the terms used herein are descriptive rather than limiting and that many changes, modifications, and substitutions may be made by one having ordinary skill in the art without departing from the spirit and scope of the invention, as set forth in the following claims.

1. A tire valve cap system comprising:
(a) a lower member having threads for engaging complementary threads on a tire valve stem; and
(b) an upper member movable over the lower member between an upward orientation and a downward orientation relative to the lower member.

2. The tire valve cap system as defined in claim 1, further comprising a biasing member for biasing the lower member toward its upward orientation.

3. The tire valve cap system as defined in claim 1, further comprising a cover for selectively covering and uncovering an opening in an upper end of the upper member.

4. The tire valve cap system as defined in claim 1, further comprising a structure for latching the upper member in its downward orientation.

5. The tire valve cap system as defined in claim 3, wherein the cover is hinged to the upper end of the upper member.

6. The tire valve cap system as defined in claim 5, further comprising a catch mechanism for latching the cover in its closed orientation.

7. The tire valve cap system as defined in claim 3, wherein the cover is substantially flat.

8. The tire valve cap system as defined in claim 3, wherein the cover is rounded.

9. A method for servicing a pneumatic tire having a valve stem cap with a lower member having threads for engaging complementary threads on a tire valve stem and an upper member movable over the lower member between an upward orientation and a downward orientation relative to the lower member, said method comprising the steps of:
(a) moving a cover over the tire valve stem to an open orientation;
(b) pushing a device for checking air pressure or inserting air onto the tire valve stem;
c) pushing the upper member downwardly over the lower member to thereby expose the tire valve stem;
(d) servicing the tire; and
(e) removing the device from the tire valve stem.

10. The method as defined in claim 9 and further comprising a step of returning the upper member to its upward orientation.

11. The method as defined in claim 9 wherein the step of pushing the upper member is performed when the step of pushing said device is performed.

12. The method as defined in claim 9 wherein the step of pushing the upper member includes a step of locking the upper member in its downward orientation.
